(19) United States
(12) Patent Application Publication
(10) Pub. No.: US 2007/0227875 A1
(43) Pub. Date: Oct. 4, 2007

(54) Method of Distilling Product Mixtures

(75) Inventor: Peter Kammerhofer, Burgkirchen (DE)

Correspondence Address: EDWARDS ANGELL PALMER & DODGE LLP, P.O. BOX 55874, BOSTON, MA, 02205, US

(73) Assignee: Vinnoilt Technolgie GmbH & Co. KG, Burgkirchen (DE)

(21) Appl. No.: 11/579,765

(22) PCT Filed: May 9, 2005
(86) PCT No.: PCT/EP05/05001

§ 371 Date: Nov. 7, 2006

(30) Foreign Application Priority Data
May 7, 2004 (DE) 10 2004 022 734.9

(51) Int. Cl. B01D 3/16

(52) U.S. Cl. 203/71; 202/232; 203/98; 203/99

(57) ABSTRACT

The invention relates to a method of separating product mixtures, especially using a distillation column, it being possible preferably for the method to be used in purifying 1,2-dichloroethane. By that means, impurities and/or subsidiary products (high-boilers and low-boilers) can be simultaneously separated off virtually quantitatively in only one distillation column.

The invention relates to a method of separating product mixtures, especially using a distillation column, it being possible preferably for the method to be used in purifying 1,2-dichloroethane (EDC).

1,2-Dichloroethane (ethylene dichloride, EDC) as a preliminary product for the production of vinyl chloride (VC) is prepared on a large industrial scale by two different methods. One method is so-called direct chlorination (DC), in which ethylene and chlorine in the liquid phase are reacted with the aid of a homogeneous catalyst system to form EDC. A further method is so-called oxychlorination (OC), in which ethylene, hydrogen chloride and oxygen in the gaseous phase are reacted with the aid of a heterogeneous catalyst system to form EDC. The crude EDC (DC-EDC and OC-EDC) produced by the two methods has to be subjected to purification by distillation before being converted into VC by thermal cracking (EDC cracking, pyrolysis). In EDC cracking, an amount of 40-50% of the total EDC used is usually not reacted; this can be recovered as so-called “recycled EDC” but may be contaminated with various subsidiary products. The recycled EDC likewise has to be purified by distillation before it can be fed back into the production process.

From DE 199 53 762 C2 it is known to carry out the purification of crude EDC and recycled EDC with the aid of at least three distillation columns.

FIG. 4 shows a flow diagram for known EDC purification, in which the crude EDC (OC-EDC, 43) is pre-purified by separating off so-called low-boilers and water in a combined low-boiler and dehydration column (40), herein as well as in the present invention the term “low-boilers” denoting all components that have a boiling point below that of EDC, that is to say all components that have a boiling point which is less than 84° C.; correspondingly, the term “high-boilers” denotes all components that have a boiling point above that of EDC, that is to say all components that have a boiling point which is higher than 84° C. After low-boiler chlorination (see below), the EDC feed streams of OC-EDC (44) and recycled EDC (45) are distilled in combination with one another in a central high-boiler column (41) in a continuous process in order to separate off the high-boilers. The bottoms stream of the high-boiler column (41) is concentrated in an additional vacuum distillation column (42) in order to recover EDC.

DE 197 18 003 describes the prior chlorination, referred to as low-boiler chlorination, of benzene present in the recycled EDC stream using chlorine with the aid of a catalyst to form chlorobenzenes, this being a precondition for the distillation approach described above.

The purification method described above is in widespread use in practice but has the disadvantage that the purification is necessarily carried out in three distillation columns (40, 41, 42) and as a result is associated with high investment and operating costs. The considerable cleaning work moreover gives rise to high costs, not least because for maintenance and cleaning of the different columns (40, 41, 42) the continuous process has to be interrupted, which results in additional system downtime. In addition, it is necessary in this distillation approach for the chlorination of benzene to be carried out in a solid-bed reactor filled with catalyst, which gives rise to further investment and operating costs. All these disadvantages reduce the economic viability of the method.

In addition, this method has the substantial disadvantage that it does not allow subsidiary products and impurities which have a boiling point similar to that of EDC, such as, for example, benzene and 1,1-dichloroethane originating from the recycled EDC, and/or low-boiling impurities originating from the DC-EDC (such as, for example, ethylene and hydrogen chloride) to be separated off sufficiently completely for the EDC obtained to meet the internationally customary specifications for EDC destined for sale (saleable EDC) in respect of high-boiler content and low-boiler content (see Table 1).

TABLE 1
Specification for the purity of saleable EDC; all figures in ppm by weight

| | |
|---|---|
| Water | <10 |
| Total low-boilers | <100 |
| Total high-boilers | <200 |
| 1,2-Dichloroethane excluding water | >99.97% |

For the purpose of achieving the requisite saleable EDC quality, working-up of recycled EDC and crude EDC is carried out, in accordance with the prior art, in two different columns for high-boiler separation, in order to remove the above-mentioned subsidiary products and impurities. By means of the separate distillation in two columns, an EDC quality is produced in one column which is used again as “feed EDC” in cracking and in the other column the EDC from DC and OC is purified in such a way that high-purity or saleable EDC can be obtained.

The problem of the invention is to provide a method of simultaneously separating off high-boiling impurities, low-boiling impurities and other impurities that boil at about or close to the boiling point of the product, which method additionally allows the direct removal of different product qualities. Furthermore, the problem of the invention is to provide an apparatus allowing this method to be carried out.

The problem is solved by the subject-matter of the independent claims. Features of advantageous embodiments are defined in the dependent claims.

The invention relates to a method of distilling at least two different product mixtures. In the process, at least two different product mixtures are introduced through column feed lines into a vertical distillation column having a plurality of trays and column feed lines. Available in the distillation column are at least one product discharge line, a rectifying section, a stripping section, a sump section and a head section. Also provided is at least one vertical dividing wall, which divides at least part of the rectifying section and at least part of the stripping section but neither the sump section nor the head section of the column into at least two regions. In the process, distillation is carried out and at least one product is separated off.

Using the method according to the invention, impurities and/or subsidiary products (high-boilers and low-boilers) can be separated off in only one distillation column virtually quantitatively even when their boiling point differs only insignificantly from that of the product. As a result of the use of only one column, the investment and operating costs are lower than in the case of known methods. The method can be carried out as a continuous method. Separation (purification) of the product from high-boilers and from low-boilers is carried out simultaneously. The method is suitable for the distillation (purification) of two, three or more different product mixtures. One, two, three or more different products (distillates) may be separated off.

It has been found that the method according to the invention for preferably continuous fractional distillation using only one distillation column having at least one vertical dividing wall exhibits greater separation efficiency than separation using a column that does not have a vertical dividing wall despite having the same number of separation stages (trays). As a result of the method of the present invention, a very high degree of purity is achieved, whilst at the same time there are obtained a reduction in investment costs due to the reduction in the number of apparatuses and a reduction in operating costs due to the decrease in downtime, the reduced cleaning work and the reduction in specific energy consumption.

The vertical distillation column used in the method according to the invention has at least one vertical dividing wall, which divides at least part of the rectifying section and at least part of the stripping section but neither the sump section nor the head section of the column into at least two regions (distillation chambers). As a result, the regions of the column are in fluid communication with one another by way of the head section and the sump section. Feeding (introduction) can advantageously take place at any location in the column, although feeding preferably takes place in the particular central section of the column, that is to say between the sump section and the head section, for example at about half the column height, and the column feed lines are correspondingly arranged. Separating-off of product can advantageously take place at any location in the column, and the column discharge lines are correspondingly arranged.

The column can advantageously have two, three or more dividing walls of either the same or different length. A dividing wall can extend from any tray of the stripping section up to any tray of the rectifying section; advantageously, the dividing wall can extend from one of the lower trays of the stripping section up to one of the upper trays of the rectifying section or from the bottom-most tray of the stripping section over the entire stripping section and rectifying section up to the uppermost tray of the rectifying section.

The lower section of the dividing wall and the upper section of the dividing wall can preferably be shortened or lengthened, each independently of the other, so that they extend over more or less of the horizontally arranged separating trays of the column. Accordingly, the volume of the separate distillation chambers can advantageously be adjusted as required. The material for a dividing wall can include or consist of metal; preferably, it can be of non-alloy or alloy steel. The material is selected in accordance with the requirement.

The distillation column and the at least one dividing wall are preferably vertically arranged, the invention also encompassing arrangements which are not oriented completely vertically; accordingly, arrangements of columns that depart from the vertical by 5, 10 or 20 degrees are also preferred.

Preferably, the method of distilling product mixtures can be carried out by so arranging the column feed lines and at least one product discharge line of the distillation column that the column feed lines are connected to at least one region of the column for fluid flow and the at least one product discharge line is connected to at least one other region of the column for fluid flow. Accordingly, the product mixture feed advantageously takes place into one region of the distillation column and the discharge of at least one purified product after distillation takes place from another region of the column. As a result, it is possible to obtain a product having an especially high degree of purity by separating off impurities and/or subsidiary products (high-boilers and low-boilers) virtually quantitatively even when their boiling point differs only insignificantly from that of the product.

In another embodiment, the method according to the invention can preferably be carried out by so arranging the column feed lines and at least one product discharge line of the distillation column that at least one column feed line and at least one product discharge line are connected to the same region of the column for fluid flow. Accordingly, the feed of at least one product mixture and the discharge of at least one purified product after distillation advantageously take place into the same region and from the same region, respectively, of the distillation column. As a result of this embodiment too, it is possible to obtain a product having an especially high degree of purity by separating off impurities and/or subsidiary products (high-boilers and low-boilers) virtually quantitatively even when their boiling point differs only insignificantly from that of the product.

Preferably, the method according to the invention can be carried out by connecting at least one product discharge line of the distillation column to the sump section of the column for fluid flow. Accordingly, the discharge of at least one purified product after distillation advantageously takes place from the sump section of the distillation column. As a result, it is possible to separate off high-boiling impurities and/or (subsidiary) products (high-boilers) virtually quantitatively from the product mixture in the column.

In a further preferable manner, the method according to the invention can be carried out by connecting the sump section of the distillation column to a further distillation column for fluid flow. The further distillation column can preferably be a column (high-boiler column) operable or operated under a vacuum. As a result, it is possible to carry out improved high-boiler separation.

Preferably, the method according to the invention can be carried out by connecting at least one product discharge line of the distillation column to the head section of the column for fluid flow. Accordingly, the discharge of at least one purified product after distillation advantageously takes place from the head section of the distillation column. As a result, it is possible to separate off low-boiling impurities and/or (subsidiary) products (low-boilers) virtually quantitatively from the product mixture in the column.

In a further preferable manner, the method according to the invention can be carried out by connecting the head section of the distillation column to a further distillation column for fluid flow. The further distillation column can preferably be a low-boiler column. As a result, it is possible to carry out improved low-boiler separation.

Preferably, the method according to the invention can be carried out by connecting at least one column feed line of the distillation column to an EDC stripper for fluid flow. As a result, it is possible to separate off low-boiling impurities and/or (subsidiary) products (low-boilers) such as, advantageously, HCl, virtually quantitatively from the product mixture before introduction into the column.

Preferably, the method according to the invention can be carried out by modifying the amount of vapour flowing into at least one region of the distillation column. For that purpose, at least one horizontal slide valve is provided at the lower end of at least one vertical dividing wall of the column. Special preference is given to the column having a slide valve at the lower end of each region. Preferably, each slide valve can be controlled separately so that the amount of vapour flowing into the particular region of the column can be controlled individually. As a result, individual adjustment of the composition in different regions of the column and control of the composition and purity (quality) of the products separated off are possible.

Preferably, the method according to the invention can be carried out by introducing at least one product mixture from a production method and at least one product mixture from a downstream processing method. As a result, it is possible to purify product streams from production methods and from downstream processing methods at the same time instead of separately from one another, as a result of which the investment and operating costs are lower than in the case of purification methods that are separate from one another and/or carried out in succession. In an especially preferable manner, at least one product mixture recovered from a downstream processing method can be pre-purified in an EDC stripper, before being fed into the distillation column.

Preferably, the method according to the invention can be carried out by feeding in product mixtures which each comprise a halogenated hydrocarbon. As a result, a particular halogenated hydrocarbon can be separated virtually quantitatively from impurities and/or subsidiary products (high-boilers and low-boilers) even when its boiling point differs only insignificantly from that of the impurities and/or subsidiary products.

In a further preferable manner, the method according to the invention can be carried out by feeding in product mixtures which each comprise a chlorinated hydrocarbon. As a result, a particular chlorinated hydrocarbon can be separated virtually quantitatively from impurities and/or subsidiary products (high-boilers and low-boilers) even when its boiling point differs only insignificantly from that of the impurities and/or subsidiary products.

In a further preferable manner, the method according to the invention can be carried out by feeding in product mixtures which each comprise a polychlorinated saturated hydrocarbon. As a result, a particular chlorinated saturated hydrocarbon can be separated virtually quantitatively from impurities and/or subsidiary products (high-boilers and low-boilers) even when its boiling point differs only insignificantly from that of the impurities and/or subsidiary products.

In a further preferable manner, the method according to the invention can be carried out by feeding in product mixtures which each comprise 1,2-dichloroethane. As a result, 1,2-dichloroethane (EDC) can be separated virtually quantitatively from impurities and/or subsidiary products (high-boilers and low-boilers) whose boiling points differ only insignificantly from that of EDC. It has been found that, as a result of the method according to the invention, EDC can be produced from crude EDC and recycled EDC in a quality that is suitable for sale (saleable EDC) using only one distillation column.

Preferably, the method according to the invention can be carried out by using at least one product mixture, fed in from a production method, that originates from a direct chlorination method and/or an oxychlorination method. As a result, product mixtures from direct chlorination and/or oxychlorination methods can be advantageously purified. Preferably, the at least one product mixture from oxychlorination can be pre-purified by means of an EDC stripper before being fed into the distillation column. In an especially preferable manner, EDC from oxychlorination can be pre-purified by means of an EDC stripper before being fed into the column. The pre-purification can advantageously comprise separating off HCl.

Preferably, the method according to the invention can be carried out by using at least one product mixture, fed in from a downstream processing method, that originates from thermal cracking. As a result, a product mixture from thermal cracking (pyrolysis) can be advantageously purified.

Preferably, the method according to the invention can be carried out by separating off at least one product in the form of a side-offtake stream. As a result, a product can be taken off especially advantageously from the method according to the invention. Separation takes place especially advantageously in the middle region of the distillation column, that is to say at about half the vertical column height. The product discharge lines are correspondingly arranged.

Preferably, the method according to the invention can be carried out by individually controlling the column downflows to the individual column regions by means of control valves. The control valves make it possible to adjust a modifiable amount of downflow in the individual column regions. As a result, individual adjustment of the composition in different regions of the column and control of the composition and purity (quality) of the products separated off are possible.

Preferably, the method according to the invention can be carried out by individually controlling the purity of a product separated off at the sump section, of a product separated off in the form of a side-offtake stream and of a product separated off at the head section. The control is preferably carried out by means of control valves which individually adjust the amount of products separated off in each case. As a result, individual adjustment of the composition in different regions of the column and control of the composition and purity (quality) of the products separated off are possible.

Preferably, the method according to the invention can be carried out by using the reaction heat of a production method for heating the distillation column. This dispenses not only with investment and operating costs for heating the distillation column but also with investment and operating costs for cooling the apparatus for the production method. Accordingly, it is possible to carry out the method according to the invention in energy-saving manner and with lower operating costs.

In a further preferable manner, the method according to the invention can be carried out by performing heating of the distillation column using a gaseous or liquid product mixture from a production method. As a result, it is possible to carry out the method according to the invention in energy-saving manner and with lower operating costs.

In a further preferable manner, the method according to the invention can be carried out by performing heating of the distillation column using a falling-film evaporator. As a result, it is possible to carry out the method according to the invention in energy-saving manner and with lower operating costs.

Preferably, the method according to the invention can be carried out by purifying, by means of an EDC stripper, at least one product mixture from a downstream processing method before it is fed into the distillation column. As a result, it is possible to separate off low-boiling impurities and/or (subsidiary) products (low-boilers) such as, advantageously, HCl virtually quantitatively from the product mixture before introduction into the column. Separating off HCl and other low-boilers beforehand prevents their being carried over into the distillation column and into the products purified by the method according to the invention.

Preferably, the method according to the invention can be carried out by performing additional concentration of low-boilers in a further distillation column arranged downstream of the distillation column. For that purpose, a product stream discharged from the distillation column is introduced into an additional further column. The further distillation column can preferably be a low-boiler column. As a result, it is possible to carry out additional concentration of low-boilers and improved separation of low-boilers.

In an especially preferable manner, the method according to the invention can be carried out by introducing a product mixture from a downstream processing method into a region of the distillation column and separating off a product of saleable EDC quality from another region of the column. Especially when the introduced product mixtures comprise EDC, EDC of saleable EDC quality can accordingly be separated off, by means of the method according to the invention, from a region of the distillation column when recycled EDC is fed into another region of the column.

Alternatively, in an especially preferable manner, the method according to the invention can be carried out by feeding at least one product mixture from a downstream processing method into a region of the distillation column and separating off at least one product of feed EDC quality from the same region of the column. Especially when the introduced product mixtures comprise EDC, EDC of saleable EDC quality can accordingly be separated off, by means of the method according to the invention, from a region of the distillation column when recycled EDC is fed into the same region of the column. Special preference is given to pre-purifying, by means of an EDC stripper, recycled EDC that has been recovered from EDC cracking, before it is introduced into the distillation column.

In the method according to the invention, it is accordingly possible, by selecting the side of the feed of a product mixture from a downstream processing method, to determine the purity (quality) of the product. EDC of saleable EDC quality or of feed EDC quality can especially be separated off. It is preferably possible, in accordance with the invention, depending on the amount and composition of the column feed(s) fed to the distillation chambers for purification, for different purities of distillate to be obtained in a column. This is preferably possible as a result of individual condensation of the vapours from different sections and/or regions of the columns. It is also possible, advantageously, for a desired quality of distillate to be established by mixing the two distillate streams.

The invention relates also to the use of the method according to the invention in purifying halogenated hydrocarbons, especially 1,2-dichloroethane. Purification of EDC is carried out in accordance with the invention by fractional distillation.

Special preference is given to purification of EDC from a production method (crude EDC) and of unreacted EDC from a downstream processing method (recycled EDC) in two distillation columns by combining a dividing wall distillation column with a vacuum distillation column. By that means, the investment and operating costs are significantly reduced in comparison to known methods, in which at least three columns are required (see above). Furthermore, in the method of the present invention, the EDC that is not reacted in EDC cracking (recycled EDC) is subjected not only to high-boiler separation but also, at the same time, to low-boiler separation using a similar amount of energy as in the case of the high-boiler separation described in the prior art.

Furthermore, when carrying out the method of the present invention there is no longer a necessity for chlorination of low-boiling components (low-boilers) such as, for example, benzene, as a result of which the investment and operating costs are further reduced significantly, because a solid-bed reactor filled with catalyst is required for the chlorination of benzene.

In a preferred embodiment of the invention, crude EDC and recycled EDC are introduced together into one of the distillation column regions (distillation chambers) separated by the at least one vertically inserted dividing wall. EDC of a quality suitable for sale (saleable EDC) can, in this embodiment, be removed in the form of a side-offtake stream from another region, which is separated from the introduction region by the at least one dividing wall. EDC of feed EDC quality can be obtained by removal from the sump section of the column and subsequent high-boiler separation in a further vacuum distillation column. In a further preferred embodiment, additional concentration of low-boilers can be carried out using a low-boiler column arranged downstream of the dividing wall distillation column.

In another preferred embodiment, recycled EDC from pyrolysis is first separated off from low-boilers such as, for example, HCl in an EDC stripper. The recycled EDC stream pre-purified in that manner is fed into the same distillation chamber of the column as that from which EDC of saleable EDC quality is removed, whereas crude OC-EDC from a production method is introduced into another distillation chamber and they are distilled together. In this embodiment too, feed EDC can be obtained by removal from the sump section of the column and subsequent high-boiler separation in a vacuum distillation column.

The present invention overcomes the disadvantages of the prior art, especially in that the internationally required product quality for saleable EDC is achieved using a column concatenation which is not more costly than that described in DE 199 53 762.

In particular, the investment costs are reduced as a result of reducing the number of apparatuses. Furthermore, downtime is reduced as a result of a reduction in the cleaning work due to the reduced number of apparatuses and, furthermore, the energy use is substantially reduced.

### DESCRIPTION OF THE FIGURES

In the Figures, components having the same functions are referred to by the same reference numerals.

FIG. 1 shows, in diagrammatic form, a flow diagram of a first embodiment of the invention, in which reference numerals 3 and 7 denote two distillation columns. Reference numerals 1 and 2 denote column feed lines, reference numeral 5 denotes a product discharge line provided between the two columns 3 and 7, and reference numerals 4, 6, 8 and 9 denote product discharge lines. The distillation column 3 is provided with a plurality of trays 10, at least one vertical dividing wall 13, a sump section 11 and a head section 12.

FIG. 2 shows, in diagrammatic form, a flow diagram of a second embodiment of the invention. The second embodiment differs from the first in that a third distillation column 21 is provided. Reference numerals 20, 22 and 23 denote a column feed line 20, a product discharge line 23 provided as a connecting line between the two columns 21 and 3, and a product discharge line 22.

FIG. 3 shows, in diagrammatic form, a flow diagram of a third embodiment of the invention. The third embodiment differs from the first in that a third distillation column 31 is provided. Reference numerals 30, 32 and 33 denote a product discharge line 32 and two product discharge lines 30 and 33 provided as connecting lines between the two columns 3 and 31.

FIG. 4 shows, in diagrammatic form, a flow diagram of a known method, in which reference numerals 40, 41 and 42 denote three distillation columns. Reference numerals 43 and 45 denote column feed lines, reference numerals 44 and 47 denote product discharge lines provided as connecting lines between the two columns 40 and 41, and 41 and 42, respectively, and reference numerals 46, 48 and 49 denote product discharge lines.

### LIST OF REFERENCE NUMERALS

1—crude EDC feed line from production method
2—recycled EDC feed line from downstream processing method
3—distillation column (column with dividing wall)
4—EDC discharge line (saleable EDC)
5—high-boiler discharge line
6—low-boiler discharge line
7—distillation column (high-boiler column)
8—high-boiler discharge line
9—EDC discharge line (feed EDC)
10—column trays
11—sump section of column
12—head section of column
13—dividing wall
20—recycled EDC feed line from downstream processing methods
21—EDC stripper
22—low-boiler, HCl, discharge line
23—pre-purified recycled EDC feed line
30—low-boiler discharge line
31—distillation column (low-boiler column)
32—low-boiler discharge line
33—high-boiler discharge line
40—low-boiler and dehydration column
41—high-boiler column
42—vacuum distillation column
43—crude EDC feed line from production method (OC-EDC)
44—pre-purified OC-EDC feed line
45—recycled EDC feed line from downstream processing methods
46—low-boiler discharge line
47—high-boiler discharge line
48—EDC discharge line (feed EDC)
49—high-boiler discharge line

### EXAMPLES

### Example 1

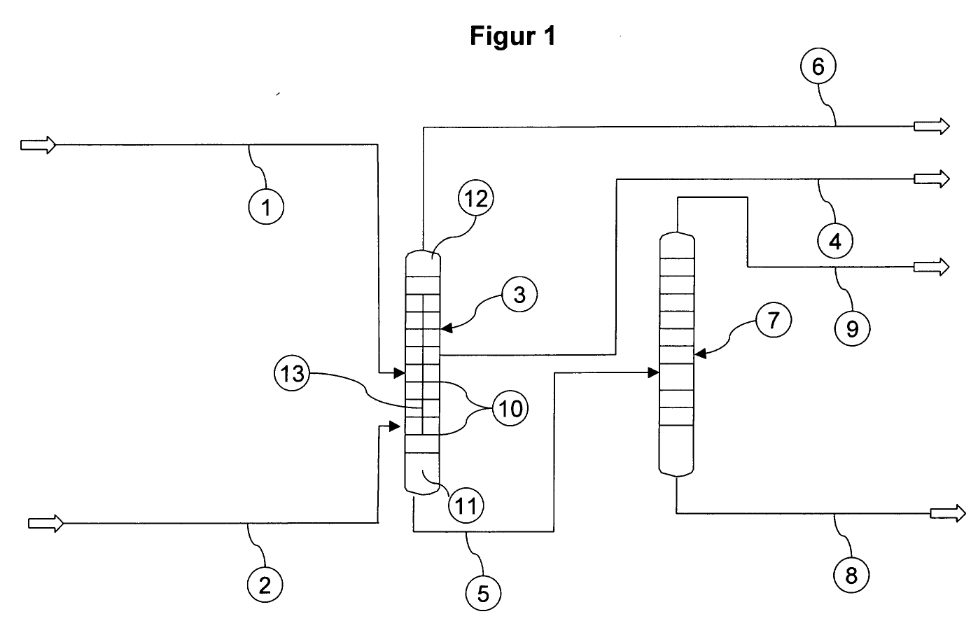

In accordance with a flow diagram shown in FIG. 1, OC-EDC and recycled EDC are purified as follows:

By way of a column feed line 1, OC-EDC (see Table 2 for purity) is fed into a region of a dividing wall distillation column 3 having a plurality of trays 10, a sump section 11, a head section 12 and a dividing wall 13. Recycled EDC (see Table 3 for purity) is fed, by way of a column feed line 2, into the same region of the dividing wall distillation column 3. Low-boilers and water, which is present in the OC-EDC, are separated off at the head 12 of the dividing wall distillation column 3 by way of a discharge line 6. Pure EDC of saleable EDC quality (see Table 4) is separated off, by way of a product discharge line 4, in the form of a side-offtake stream from another region of the dividing wall distillation column 3, to which OC-EDC 1 and recycled EDC 2 are not supplied, and is pumped, for example, into a storage tank (not shown). For concentration of the high-boiler content, a product is fed from the sump section 11 of the dividing wall distillation column 3, by way of a discharge line 5, into a vacuum distillation column 7 operated under a vacuum. High-boilers are separated off by way of a discharge line 8 of the vacuum distillation column 7. EDC of feed EDC quality is separated off as the overhead product of the vacuum distillation column 7 by way of a discharge line 9 and is returned to EDC cracking.

In accordance with the method shown in FIG. 1, the following utilities are required for purifying 25,000 kg/h of OC-EDC and 44,000 kg/h of recycled EDC:
Steam (at a gauge pressure of 3 bar): 22,800 kg/h

Cooling water: 1180 m³/h

TABLE 2
Purity of OC-EDC; all figures in ppm by weight

| | |
|---|---|
| Water | 2300 |
| Carbon tetrachloride | 653 |
| Trichloromethane | 1254 |
| Chloroethane | 135 |
| 1,1,2-Trichloroethane | 2130 |
| Trichloroacetaldehyde | 12 |
| 1,1-Dichloroethane | 31 |
| 1,1,2,2-Tetrachloroethane | 67 |
| 2-Chloroethanol | 156 |
| 1,2-Dichloroethane excluding water | 99.56% |

TABLE 3
Purity of recycled EDC; all figures in ppm by weight

| | |
|---|---|
| Water | 6 |
| Vinyl chloride | 234 |
| Carbon tetrachloride | 23 |
| Trichloromethane | 68 |
| Chloroethane | 57 |
| 1,1,2-Trichloroethane | 970 |
| Benzene | 679 |
| 1,1-Dichloroethane | 158 |
| 1,1,2,2-Tetrachloroethane | 67 |
| Chloroprene | 47 |
| Pentachlorobutane | 1370 |
| 1,2-Dichloroethane | 99.53% |

TABLE 4
Purity of saleable EDC; all figures in ppm by weight

| | |
|---|---|
| Water | 7 |
| Carbon tetrachloride | 12 |
| Trichloromethane | 10 |
| Chloroethane | 6 |
| 1,1,2-Trichloroethane | 114 |
| Trichloroacetaldehyde | 6 |
| 1,1-Dichloroethane | 7 |
| 1,1,2,2-Tetrachloroethane | 12 |
| Benzene | 34 |
| Monochloroacetaldehyde | 6 |
| 2-Chloroethanol | 12 |
| 1,2-Dichloroethane excluding water | 99.98% |

### Example 2

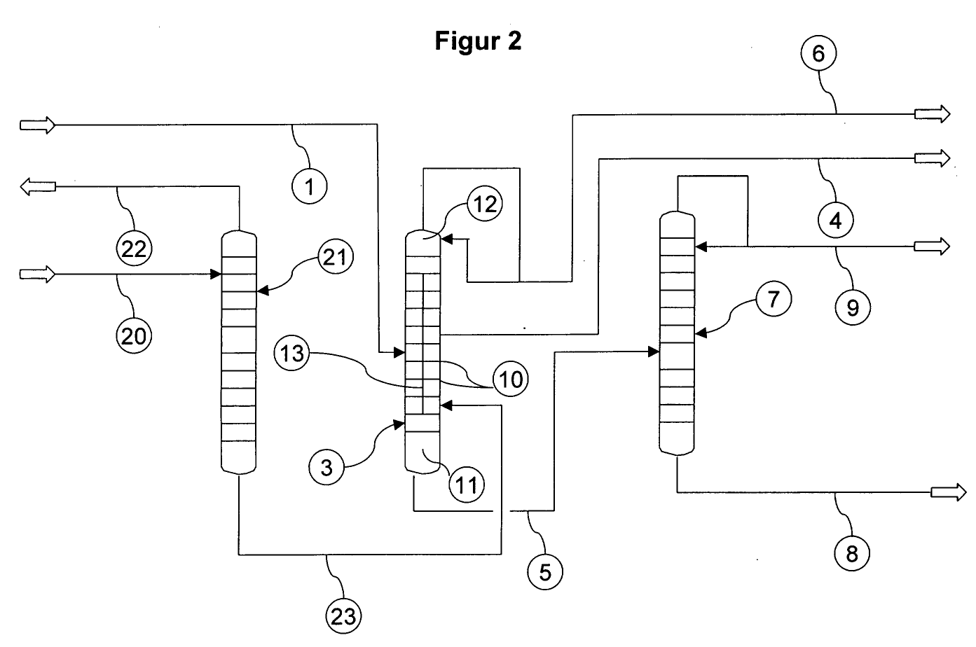

In accordance with a flow diagram shown in FIG. 2, OC-EDC and recycled EDC are purified as follows:

By way of a column feed line 1, OC-EDC (see Table 5 for purity) is fed into a region of a dividing wall distillation column 3 having a plurality of trays 10, a sump section 11, a head section 12 and a dividing wall 13. Recycled EDC (see Table 6 for purity) is fed, by way of a column feed line 20, into an EDC stripper 21 for removal of HCl. HCl is separated off as an overhead stream of the EDC stripper 21 by way of a discharge line 22 and, for example, returned to oxychlorination for HCl neutralisation. A bottoms stream of the EDC stripper 21 is fed, by way of a column feed line 23, into another region of the dividing wall distillation column 3, to which the OC-EDC 1 is not supplied, feeding being carried out in the lower half of said region. Saleable EDC (see Table 7 for purity) is separated off in the form of a side-offtake stream from that region of the column by way of a discharge line 4 arranged about in the middle of the column and is pumped, for example, into an EDC storage tank or to EDC cracking (not shown). Low-boilers and/or water are separated off as a product from a head section 12 of the dividing wall distillation column 3 by way of a discharge line 6. A product from a sump section 11 of the dividing wall distillation column 3 is fed, by way of a discharge line 5, into a vacuum distillation column 7 operated under a vacuum for concentration of the high-boiler content. High-boilers are separated off from the vacuum distillation column 7 by way of a discharge line 8. EDC of feed EDC quality is separated off as overhead product of the vacuum distillation column 7 by way of a discharge line 9 and is returned to EDC cracking.

In accordance with the method shown in FIG. 2, the following utilities are required for purifying 25,000 kg/h of EDC from oxychlorination and 44,000 kg/h of recycled EDC that has not been reacted in cracking:
Steam (at a gauge pressure of 3 bar): 24,500 kg/h

Cooling water: 1270 m³/h

TABLE 5
Purity of OC-EDC; all figures in ppm by weight

| | |
|---|---|
| Water | 2100 |
| Carbon tetrachloride | 840 |
| Trichloromethane | 1367 |
| Chloroethane | 1147 |
| 1,1,2-Trichloroethane | 2341 |
| Trichloroacetaldehyde | 9 |
| 1,1-Dichloroethane | 37 |
| 1,1,2,2-Tetrachloroethane | 89 |
| 2-Chloroethanol | 183 |
| 1,2-Dichloroethane excluding water | 99.40% |

TABLE 6
Purity of recycled EDC; all figures in ppm by weight

| | |
|---|---|
| Water | 3 |
| Vinyl chloride | 176 |
| Carbon tetrachloride | 145 |
| Trichloromethane | 258 |
| Chloroethane | 168 |
| 1,1,2-Trichloroethane | 1270 |
| Benzene | 453 |
| 1,1-Dichloroethane | 1760 |
| 1,1,2,2-Tetrachloroethane | 45 |
| Chloroprene | 8 |
| Pentachlorobutane | 1465 |
| 1,2-Dichloroethane | 99.43% |

TABLE 7
Purity of feed EDC; all figures in ppm by weight

| | |
|---|---|
| Water | 9 |
| Carbon tetrachloride | 156 |
| Trichloromethane | 293 |
| Chloroethane | 121 |
| 1,1,2-Trichloroethane | 346 |
| Trichloroacetaldehyde | 8 |
| 1,1-Dichloroethane | 1458 |
| 1,1,2,2-Tetrachloroethane | 24 |
| Benzene | 379 |
| Monochloroacetaldehyde | 8 |
| 2-Chloroethanol | 24 |
| 1,2-Dichloroethane excluding water | 99.72% |

### Example 3

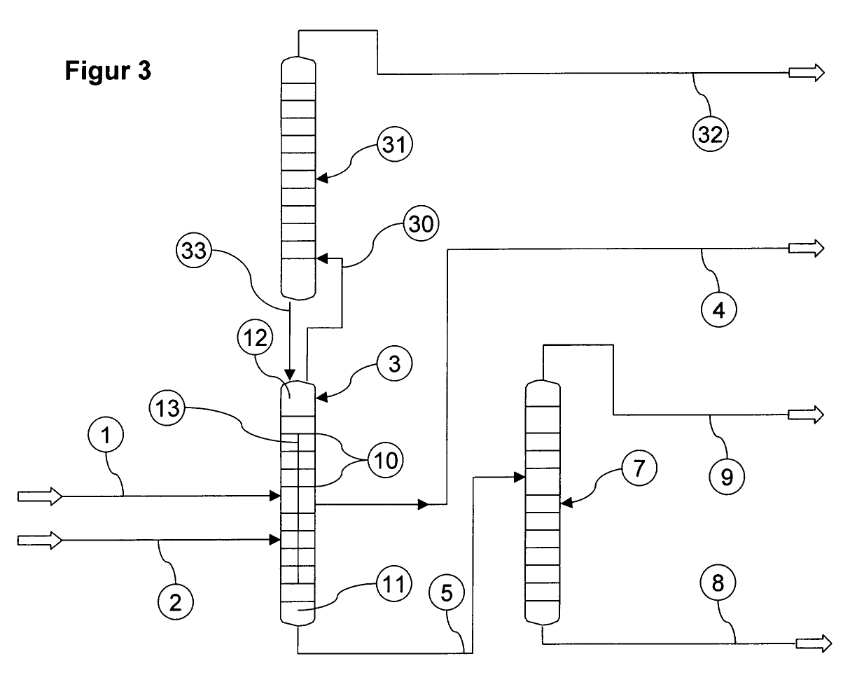

In accordance with a flow diagram shown in FIG. 3, OC-EDC and recycled EDC are purified as follows:

By way of a column feed line 1, OC-EDC (see Table 2 for purity) is fed into a region of the dividing wall distillation column 3 having a plurality of trays 10, a sump section 11, a head section 12 and a dividing wall 13. Recycled EDC (see Table 3 for purity) is fed, by way of a column feed line 2, into the same region of the dividing wall distillation column 3. At the head 12 of the dividing wall distillation column 3, a partial amount of a vapour comprising EDC/low-boilers is separated off by way of a discharge line 30 and fed into a low-boiler column 31 mounted above. Concentration of the low-boilers is carried out in this low-boiler column 31, which is operated as a rectifying column. Low-boilers and/or water is/are separated off from the low-boiler column 31 by way of a discharge line 32. Pure EDC of saleable EDC quality (see Table 4) is separated off, by way of a product discharge line 4, in the form of a side-offtake stream from another region of the dividing wall distillation column 3, to which OC-EDC 1 and recycled EDC 2 are not supplied, and is pumped, for example, into a storage tank (not shown). For concentration of the high-boiler content, a product is fed from a sump section 11 of the dividing wall distillation column 3, by way of a discharge line 5, into a vacuum distillation column 7 operated under a vacuum. High-boilers are separated off by way of a discharge line 8 of the vacuum distillation column 7. EDC of feed EDC quality is separated off as the overhead product of the vacuum distillation column 7 by way of a discharge line 9 and is returned to EDC cracking.

In accordance with the method shown in FIG. 3, the following utilities are required for purifying 25,000 kg/h of OC-EDC and 44,000 kg/h of recycled EDC:
Steam (at a gauge pressure of 3 bar): 21,500 kg/h
Cooling water: 1090 m³/h

### Comparison Example 1

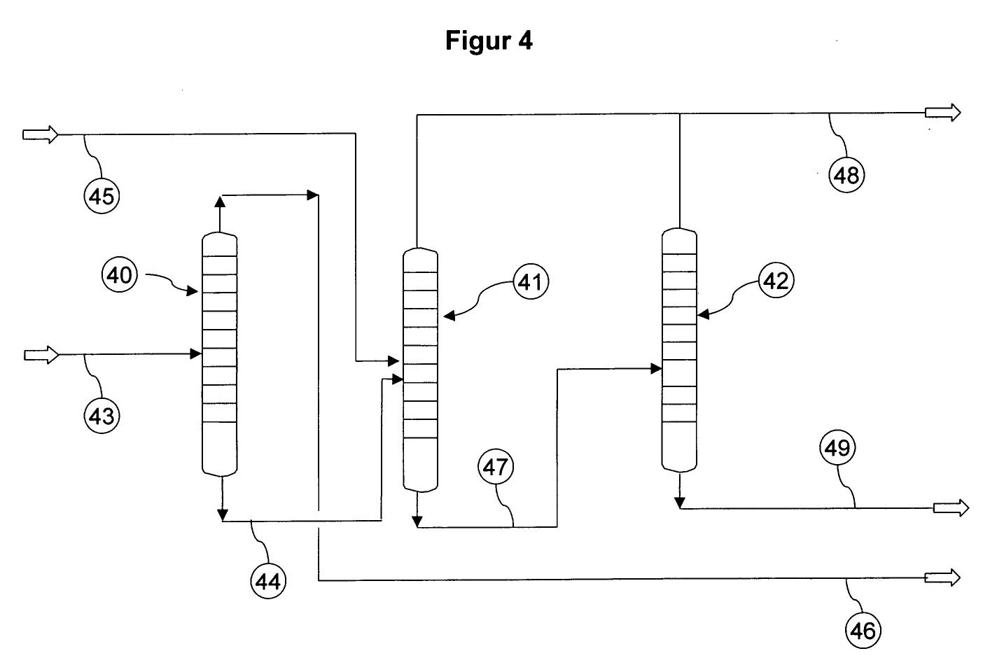

In accordance with a flow diagram shown in FIG. 4, OC-EDC and recycled EDC are purified as follows according to the prior art:

By way of a feed line 43, OC-EDC is fed into a combined low-boiler and dehydration column 40. Low-boilers and water are separated off by way of a discharge line 46 as an overhead product of the low-boiler and dehydration column 40. High-boilers are separated off by way of a discharge line 44 as a sump product of the low-boiler and dehydration column 40 and are fed into a high-boiler column 41. Recycled EDC, following additional prior low-boiler chlorination (not shown), is also fed into the high-boiler column 41 by way of a feed line 45. EDC of feed EDC quality is separated off as an overhead product of the high-boiler column 41 by way of a discharge line 48 and is returned to EDC cracking. A sump product of the high-boiler column 41 is separated off by way of a discharge line 47 and is fed into a vacuum distillation column 42 operated under a vacuum. High-boilers are separated off as a sump product of the vacuum distillation column 42 by way of a discharge line 49. EDC of feed EDC quality is separated off as an overhead product of the vacuum distillation column 42 by way of a discharge line 48 and is returned to EDC cracking.

In accordance with the method shown in FIG. 4, the following utilities are required for purifying 25,000 kg/h of OC-EDC and 44,000 kg/h of recycled EDC:
Steam (at a gauge pressure of 3 bar): 25,500 kg/h
Cooling water: 1350 m³/h

The following Table summarises the embodiments of the invention and the prior art:

| | Comparison | | | |
|---|---|---|---|---|
| | Example 1 | Example 1 | Example 2 | Example 3 |
| | (FIG. 4) | (FIG. 1) | (FIG. 2) | (FIG. 3) |
| Number of | 3 | 2 | 3 | 3 |
| columns | | | | |
| Number of | 4 | 3 | 4 | 3 |
| forced- | | | | |
| circulation | | | | |
| reboilers | | | | |
| Number of | 3 | 2 | 3 | 3 |
| condensers | | | | |
| Low-boiler | Yes | No | No | No |
| chlorination | | | | |
| necessary | | | | |
| Steam usage in | 370 | 330 | 355 | 312 |
| kg/t of EDC | | | | |
| Cooling water | 19.6 | 17.1 | 18.4 | 15.8 |
| usage in m³/t of | | | | |
| EDC | | | | |

Definitions:
EDC=1,2-dichloroethane
VC=vinyl chloride
high-boilers=subsidiary products having a boiling point of >84° C. at atmospheric pressure
low-boilers=subsidiary products having a boiling point of <84° C. at atmospheric pressure
middle-boilers=for example, benzene having a boiling point of 80° C.
enriching column=column for the concentration of low-boilers
low-boiler chlorination=low-boilers are converted into high-boilers by reaction with chlorine
rectifying section of a column=that section of the column which is located above the column feed tray
stripping section of a column=that section of the column which is located below the column feed tray

1-27. (canceled)

28. A method of distilling at least two different product mixtures, comprising:
introducing at least two different product mixtures through column feed lines into a vertical distillation column comprising a plurality of trays and column feed lines, at least one product discharge line, a rectifying section, a stripping section, a sump section and a head section, and at least one vertical dividing wall which divides at least part of the rectifying section and at least part of the stripping section but neither the sump section nor the head section of the column into at least two regions, and
distilling the at least two different product mixtures.

29. The method of claim 28 wherein at least one product is separated by the distilling.

30. The method of claim 28 wherein the column feed lines and at least one product discharge line of the distillation column are so arranged that the column feed lines are connected to at least one region of the column for fluid flow and the at least one product discharge line is connected to at least one other region of the column for fluid flow.

31. The method of claim 28 wherein the column feed lines and at least one product discharge line of the distillation column are so arranged that at least one column feed line and the at least one product discharge line are connected to the same region of the column for fluid flow.

32. The method of claim 28 wherein at least one product discharge line of the distillation column is connected to the sump section of the column for fluid flow.

33. The method of claim 28 wherein the sump section of the distillation column is connected to a further distillation column for fluid flow.

34. The method of claim 28 wherein the at least one product discharge line of the distillation column is connected to the head section of the column for fluid flow.

35. The method of claim 28 wherein the head section of the distillation column is connected to a further distillation column for fluid flow.

36. The method of claim 28 wherein at least one column feed line of the distillation column is connected to an EDC stripper for fluid flow.

37. The method of claim 28 wherein at least one horizontal slide valve is provided at the lower end of at least one vertical dividing wall of the distillation column for modifying the amount of vapour flowing into at least one region of the column.

38. The method of claim 28 wherein the introduced product mixtures comprise at least one product mixture from a production method and at least one product mixture from a downstream processing method.

39. The method of claim 28 wherein the introduced product mixtures each comprise a halogenated hydrocarbon.

40. The method of claim 28 wherein the introduced product mixtures each comprise a chlorinated hydrocarbon.

41. The method of claim 28 wherein the introduced product mixtures each comprise a polychlorinated saturated hydrocarbon.

42. The method of claim 28 wherein the introduced product mixtures each comprise 1,2-dichloroethane.

43. The method of claim 28 wherein at least one introduced product mixture is derived from a direct chlorination method and/or an oxychlorination method.

44. The method of claim 28 wherein at least one introduced product mixture is derived from a thermal cracking downstream processing method.

45. The method of claim 29 wherein at least one product mixture is separated in the form of a side-offtake stream.

46. The method of claim 28 wherein the column downflows to individual column regions are individually controlled by control valves.

47. The method of claim 28 wherein the purity of a product separated off at the sump section, the purity of a product separated off in the form of a side-offtake stream and the purity of a product separated off at the head section are individually controlled.

48. The method of claim 28 wherein the reaction heat of a production method is used for heating the column.

49. The method of claim 28 wherein heating of the column is carried out using a gaseous or liquid product mixture from a production method.

50. The method of claim 28 wherein heating of the column is carried out using a falling-film evaporator.

51. The method of claim 28 wherein at least one product mixture from a downstream processing method is purified by means of an EDC stripper before being fed into the column.

52. The method of claim 28 wherein additional concentration of low-boilers is carried out in a further distillation column arranged downstream of the column.

53. The method of claim 28 wherein at least one product mixture from a downstream processing method is fed into one region of the column and at least one product of saleable EDC quality is separated off from another region of the column.

54. The method of claim 28 wherein at least one product mixture from a downstream processing method is fed into one region of the column and at least one product of feed EDC quality is separated off from the same region of the column.

55. A distillation system, comprising:
a vertical distillation column comprising a plurality of trays and column feed lines, at least one product discharge line, a rectifying section, a stripping section, a sump section and a head section, and at least one vertical dividing wall which divides at least part of the rectifying section and at least part of the stripping section but neither the sump section nor the head section of the column into at least two regions, and
at least two different product mixtures through column feed lines into the distillation column.
